(19) United States
(12) Patent Application Publication
(10) Pub. No.: US 2026/0233933 A1
(43) Pub. Date: Aug. 13, 2026

(54) APPARATUS FOR SORTING AND STORING DEVICES

(71) Applicant: Communications Test Design, Inc., West Chester, PA (US)

(72) Inventors: Prakhar SINGH, West Chester, PA (US); Soham PATWARDHAN, West Chester, PA (US); Thushananth RAJENDRA, West Chester, PA (US); Kirk WHITTEMORE, West Chester, PA (US); Joseph ROACH, West Chester, PA (US); Krissy DURKIN, West Chester, PA (US); Jonathan BOORAEM, West Chester, PA (US)

(73) Assignee: Communications Test Design, Inc., West Chester, PA (US)

(21) Appl. No.: 19/049,503

(22) Filed: Feb. 10, 2025

(51) Int. Cl. B65G 1/137; B25J 9/00; B65G 1/04; G05B 19/05

(52) U.S. Cl. CPC B65G 1/1371; B25J 9/0093; B65G 1/045; G05B 19/054; B65G 2203/0216; B65G 2203/041; G05B 2219/13003

(57) ABSTRACT

An apparatus for sorting and storing devices is shown and described. The apparatus for sorting and storing devices includes a frame configured to support a robot arm. The robot arm has a grabber secured to one end. At least one rack is positioned within reach of the robot arm. A computer operably coupled with the robot arm.

### BACKGROUND OF THE INVENTION

Technology is always advancing and has done so at a rapid pace for the last several decades. Technology has become sophisticated, smaller, and accessible across the globe. This has led to technology becoming integral in everyday life. As with any integral element of life, the demand is high. This high demand has led to a rise in the cost of technological devices.

In addition to high demand, the simple replacement of devices can be expensive. If one merely discards older equipment or equipment with minor defects for a brand-new piece the cost can escalate quickly. If, however, technology is upgraded, or repaired this process can be much more cost effective for both the company and consumer.

In some instances, part of the repair process includes sorting or separating devices. This sorting can be monotonous over a full shift. This monotony may lead to mistakes being made over time. By automating the sorting itself does not reduce the labor force needed but removes any errors from sorting of devices. Further, but automating the sorting process this process can be done much quicker. A person may have to move from container type to container type. This can add a significant amount of time to the sorting process and thus reduce production.

Many companies have been taking advantage of the repair instead of discard philosophy. Further, many consumers are happy purchasing a lightly used and repaired device instead of a brand new one. However, these processes come with new challenges in order to remain effective. Consequently, there is always a need for an improvement in the art.

### SUMMARY OF THE INVENTION

The present invention provides an apparatus for sorting and storing devices wherein the same can be utilized for providing convenience for the user when sorting and storing items. The apparatus for sorting and storing devices includes a frame configured to support a robot arm. The robot arm has a grabber secured to one end. At least one rack is positioned within reach of the robot arm. A computer operably coupled with the robot arm.

Another object of the apparatus for sorting and storing devices is to have a scanner secured to the frame wherein the scanner is operably coupled to the computer.

Another object of the apparatus for sorting and storing devices is to have the plurality of racks are arranged in a circular structure around the robot arm.

Another object of the apparatus for sorting and storing devices is to have each rack of the plurality of racks contains a predetermined number of slots.

Another object of the apparatus for sorting and storing devices is to have a 3D camera system secured to the frame.

Another object of the apparatus for sorting and storing devices is to have a first conveyor. The first conveyor is configured to bring a device into range of the robot arm.

Another object of the apparatus for sorting and storing devices is to have the first conveyor further configured to removed devices from the range of the robot arm.

Another object of the apparatus for sorting and storing devices is to have a second conveyor.

Another object of the apparatus for sorting and storing devices is to have the second conveyor configured to remove devices from the range of the robot arm.

Another object of the apparatus for sorting and storing devices is to have a first carton placed on the first conveyor. The first carton is configured to hold devices.

Another object of the apparatus for sorting and storing devices is to have a second carton placed on the second conveyor. The second carton is configured to hold devices.

Another object of the apparatus for sorting and storing devices is to have the computer host a programmable logic controller.

Another object of the apparatus for sorting and storing devices is to have the programmable logic controller configured to operate the robot arm in order to place devices in the at least one rack and remove devices from the at least one rack.

Another object of the apparatus for sorting and storing devices is to have the logic locate the first and closest available rack and slot on that rack where a device can be placed.

Another object of the apparatus for sorting and storing devices is to have the logic locate the first and closest available device which is needed and removes that device from the location.

Another object of the apparatus for sorting and storing devices is to have the programmable logic controller configured to run a warehouse execution system (WES).

Another object of the apparatus for sorting and storing devices is to have the WES determine exact placement of the devices on the at least one rack of the sorting apparatus.

Other objects, features and advantages of the present invention will become apparent from the following detailed description taken in conjunction with the accompanying drawings.

### BRIEF DESCRIPTION OF THE DRAWINGS

The accompanying drawings are incorporated in and are to be considered part of the present specification. These drawings are meant to aid the reader's understanding and comprehension of the present disclosure and are depictions of various example embodiments. The drawings are not to be considered limiting upon the disclosure. It should specifically be noted that the drawings are examples and may not necessarily be drawn to scale.

FIG. 1 shows a block diagram of a computing system.

FIG. 2A shows a front view of an example of a mobile phone device.

FIG. 2B shows a rear view of an example of a mobile phone device.

FIG. 3 shows a top down perspective view of an embodiment of the apparatus for sorting and storing devices.

FIG. 4 shows an interior side view of an embodiment of the apparatus for sorting and storing devices.

FIG. 5 shows a flow chart of an embodiment of the method used by the apparatus to sort and store devices.

### DETAILED DESCRIPTION OF THE INVENTION

For the purposes of presenting a brief and clear description of the present invention, a preferred embodiment will be discussed as used for the apparatus for sorting and storing devices. The figures are intended for representative purposes only and should not be considered to be limiting in any respect.

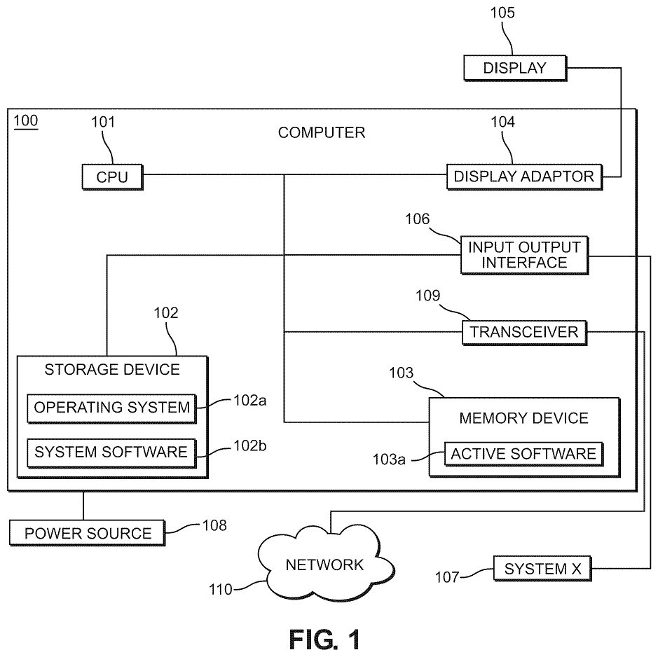

Referring now to FIG. 1, there is shown a block diagram of a computing system. Computing systems may have many interchangeable parts or multiples of some parts. One of ordinary skill in the art will understand that the shown computer 100 is a basic computing system demonstrating a minimal amount of parts to allow for the computer to function. Computer 100 is exemplary, and one of ordinary skill in the art will recognize that computer 100 may be altered as necessary to render the presently disclosed system operable or to provide a peak performance of the disclosed system.

The parts described are each operably coupled together as necessary, one of ordinary skill in the art will understand how to connect general computer components, for example by use of a mother board or other computer board. In the shown embodiment the computer 100 includes a CPU 101. In one embodiment the CPU 101 includes only one processor. In other embodiments the CPU 101 may be made up of multiple processors. Different processors will allow for different computing power and speed.

The computer 100 includes at least one storage device 102. In different embodiments the at least one storage device 102 may be a solid-state storage device, a disk storage device, or another suitable storage device. One of ordinary skill in the art will recognize that there are several types of computing storage devices each providing well-known benefits and drawbacks. The at least one storage device 102 will store at least the computer operating system 102a and system software 102b. System software 102b may include any software necessary, or optionally, used to run any system described herein.

The computer 100 will have at least one memory device 103. One of ordinary skill in the art will recognize that there are several types of computing memory devices each providing well known benefits and drawbacks. The at least one memory device 103 will store at any active software 103a. Active software 103a may include the operating system 102a or parts of the system software 102b. The at least one memory device 103 may store the entire system software 102b size and speed permitting.

The computer 100 may also include various connection ports and types. The computer 100 may have a display adaptor 104. The display adaptor 104 will allow the computer 100 to connect to at least one display 105. In other embodiments multiple displays may be connected to the display adaptor 104. Similarly, the computer 100 may include at least one input/output interface 106. The input/output interface 106 will allow the computer 100 to connect to at least one system, referred to as System X 107 in FIG. 1. The input/output interface 106 may also allow for connection to only part of System X 107 or multiple systems. The computer 100 will also be operably connected to a required power source 108.

The computer 100 may also include a transceiver 109. In one embodiment the transceiver 109 is a wired transceiver. In another embodiment the transceiver 109 is a wireless transceiver. The transceiver 109 will allow the computer 100 to connect to a network 110. The network 110 may be an internet or an intranet connection. The network 110 will allow for the computer 100 to potentially connect to multiple other computing devices. In another embodiment the network may allow for the computer 100 to connect to multiple systems. In one embodiment the computer 100 will allow for System X 107 to be connected to the network 110.

While the description of FIG. 1 describes a general computer, in different embodiments different computers can be used. For example, in one embodiment a typical over-the-counter computer can be used. In this embodiment over the counter means a computer that would be used at home such as a laptop or desktop computer. In another embodiment special industrial computers are used. These computers may be custom built to specific orders. An industrial computer can host a programmable logic controller which can run the system as described herein. However, each of these computers have the general components as described. The main difference here is the computing power and components size.

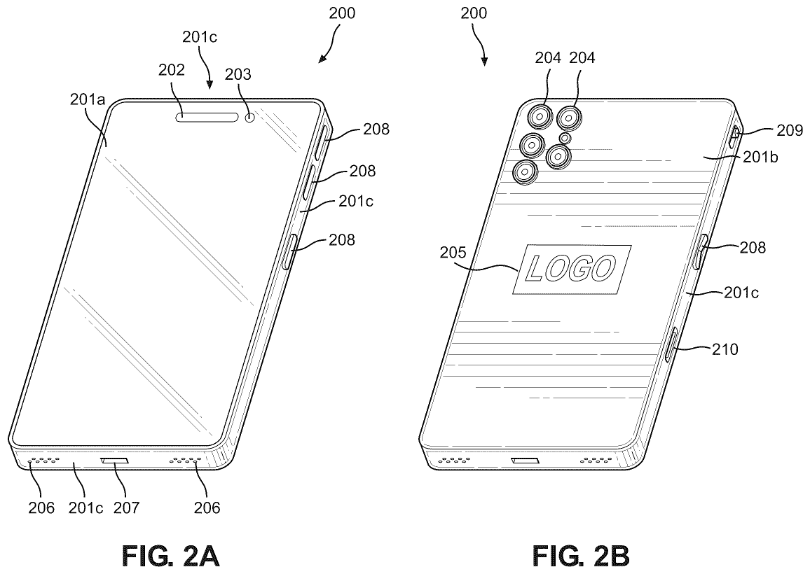

Referring now to FIG. 2A and FIG. 2B, there is shown a front view and a rear view of an example of an electronic device 200, such as a mobile phone device. Electronic devices may have many different parts and components. Even like parts or components may be in various locations or have different shapes and sizes. One of ordinary skill in the art will understand that the shown electronic device 200 is merely an example of the exterior of a device. Any specialized or specific features or requirements of devices will be detailed herein as necessary. However, one of ordinary skill in the art will understand that many electronic devices 200 have many of these described characteristics. Further, electronic devices, such as mobile phone devices, operate on a computer-based platform having many of the computer parts as described in FIG. 1. The below description seeks to detail external components and not the computer which runs the electronic device 200. The electronic device 200 can be, without limitation, a mobile phone device, or a tablet. In one embodiment other electronic devices may be used such as laptops, cable set top boxes, routers, or antennas.

The shown electronic device 200 includes a front surface 201a, a rear surface 201b, and four side surfaces 201c. The front surface 201a typically includes a screen which covers a majority of the surface. The screen is typically covered with a specialized material, currently a glass product. The front surface 201a may also include a speaker opening 202 and a camera opening 203.

The rear surface 201b of the electronic device 200 may include at least one camera lens 204. In the shown embodiment there are a plurality of camera lenses 204. In another embodiment at least one light lens is secured to the rear surface 201b. In many embodiments the rear surface 201b includes a logo 205. The logo 205 may represent the company which created the electronic device 200. The rear surface 201b may include a coating or covering to decorate or protect the rear surface. For example, a coating may be applied to the rear surface 201b to ensure a shiny surface.

The side surfaces 201c of the electronic device 200 may include any or all of the following parts. In one embodiment the electronic device 200 will have several openings for speaker output 206. The electronic device 200 will also include a charging port 207. Charging ports 207 may include a prong therein to secure to a charging cord. An electronic device 200 may include a plurality of buttons 208 along the side surfaces 201c. In different embodiments the plurality of buttons 208 may allow for volume control, locking the electronic device 200, or other desired functions. In some embodiments the electronic device 200 may include a switch 209. In yet another embodiment the electronic device 200 includes a SIM card slot or other card slot 210.

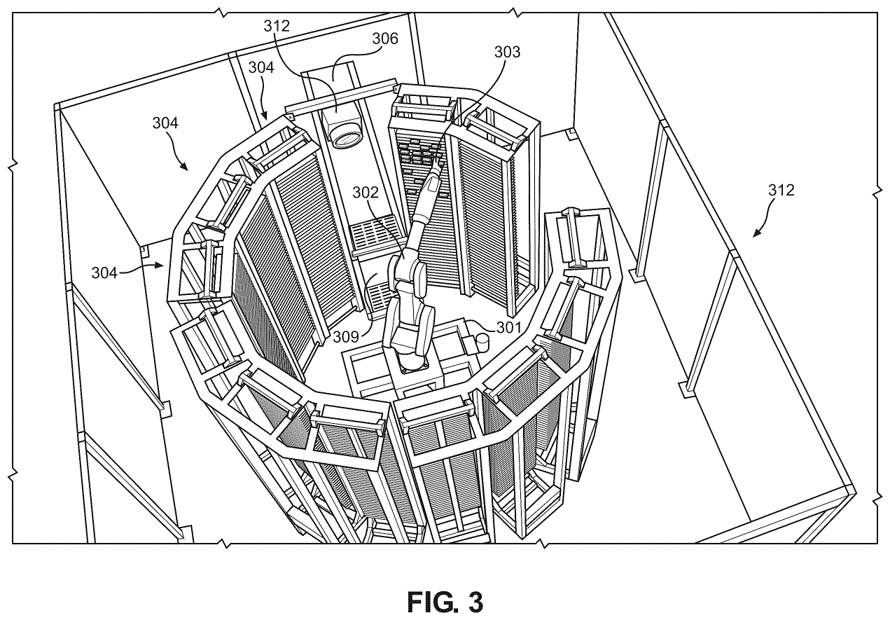

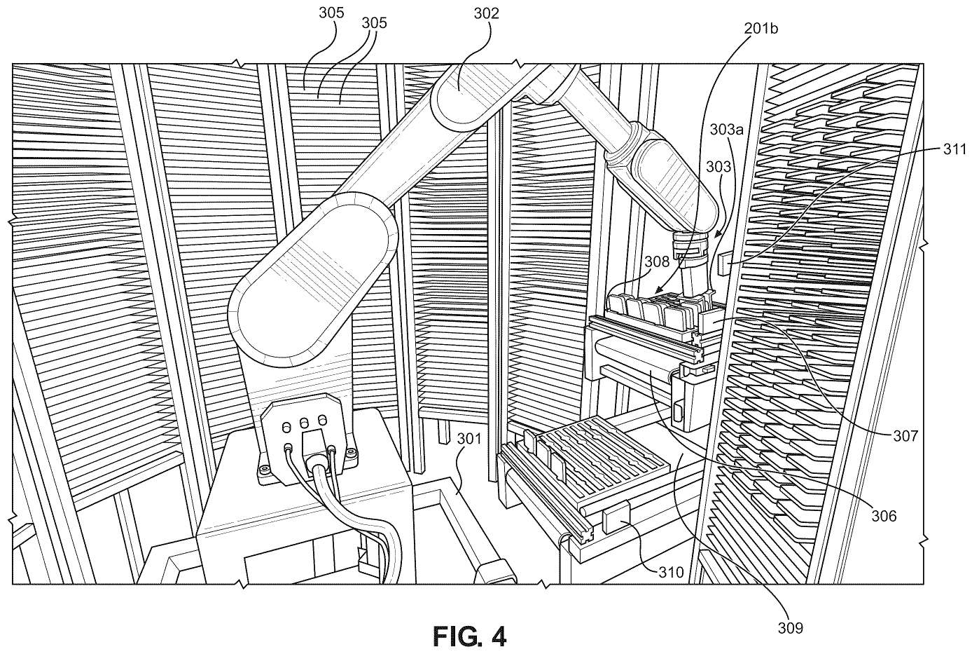

Referring now to FIG. 3 and FIG. 4, there is shown two views of an embodiment of the apparatus for sorting and storing devices. The apparatus for sorting and storing devices includes a first frame 301. The first frame 301 is designed and configured to support a robot arm 302. In different embodiment different configurations can be used for the first frame 301. These configuration differences can be due to a number of factors such as the floor under the first frame 301 or the robot arm 302 to be supported.

In addition, various robot arms can be used in order for the apparatus to function in the described manner. The robot arm 302 used should be able to move in multiple axes and have the ability for a desired gripper 303 to be added to the end of the arm. In the shown embodiment the gripper 303 includes two thin and flat fingers 303a. The combination of the fingers 303a allow for the gripper to pick up a mobile device, for example, and place it in a desired location, as described below. Further descriptions of robot arm 302 choice and gripper 303 choice will be described below.

The shown apparatus includes a plurality of storage racks 304. While the shown apparatus has a plurality of storage racks 304 a single rack could be used without departing from the present invention. In the shown embodiment the plurality of racks 304 are placed in a circular configuration around the robot arm 302. This pattern allows for the robot arm 302 to reach the highest number of racks 304 and therefore store the highest number of devices at one time. In the shown embodiment there are twelve racks 304 having two openings into the circular pattern. A different number of racks 304 could be used depending on rack size. The robot arm 302 selected for use should be able to reach each of the racks 304.

Each of the racks 304 include a plurality of slots 305 therein. In the shown embodiment each of the slots 305 is able to hold a mobile device. However, the slots could be configured to hold any desired item. The size of the slots 305 will be in part dictated by the item to be placed on the racks 304. However, the slot 305 configurations can also be dictated by gripper 303. The smaller the gripper 303 the closer together the slots 305 can be placed.

In one embodiment a first conveyer 306 enterers the circle rack 304 structure. At least one sensor 307 is attached to the end of the first conveyer 306. The sensor 307 will detect when an item is on the first conveyer 306 and stop the first conveyer 306 before the item is propelled off of the end of the first conveyer 306. In one embodiment the first conveyer 306 is used to bring a carton 308 of devices into the circle. In this embodiment the same first conveyer 306 can be used to remove a carton of different devices as needed.

In one embodiment in order to ensure the robot arm 302 can properly remove an electronic device from a carton 308 a 3D vision system is used. An image can be taken of the incoming carton using a 3D camera 312. In one embodiment When the carton 308 comes to a stop the first conveyor 306 and the sensor 307 is triggered a command is sent to the 3D camera 312 and an image is taken. In one embodiment, the 3D camera 312 is mounted above the first conveyor 306 at an angle looking at the back surface 201b of the electronic devices. After an image is taken it can be used to generate a 3D point cloud of the image and use algorithms which detect flat regions within that point cloud. The system can then assign coordinates x, y, z to each detected flat region. The system then uses the coordinates one at a time to enable the robot arm 302 to pick up electronic devices. In this embodiment the carton 308 does not have to be placed in an exact location each time for the system to properly function but can have a dynamic location generator.

In another embodiment the first conveyer 306 can only be used to bring in cartons of items to be sorted and removed the empty carton 308. In this embodiment a second conveyer 309 enterers the circle rack 304 structure. At least one sensor 310 is attached to the end of the second conveyer 309. The sensor 310 will detect when an item is on the second conveyer 309 and stop the second conveyer 309 before the item is propelled off of the end of the second conveyer 309. In this embodiment the second conveyer 309 can be used to remove items or cartons 308 from the circle rack 304 structure.

In order to sort items, the system has to be made aware of what each item is when the robot arm 302 and gripper 303 combination picks it up. In one embodiment a label can be attached to the item. In these embodiments a scanner 311 is located adjacent to the first conveyor 306. As described below the scanner 311 can be used to scan the label and inform the system on the item type.

In some embodiments work environment rules require safety cages to be put in place. In FIG. 3 there is a safety cage 312 shown around the entirety of the apparatus. One of ordinary skill in the art would understand how to secure sensors to the safety cage 312 which will deactivate the robot arm 302 if the cage 312 is open.

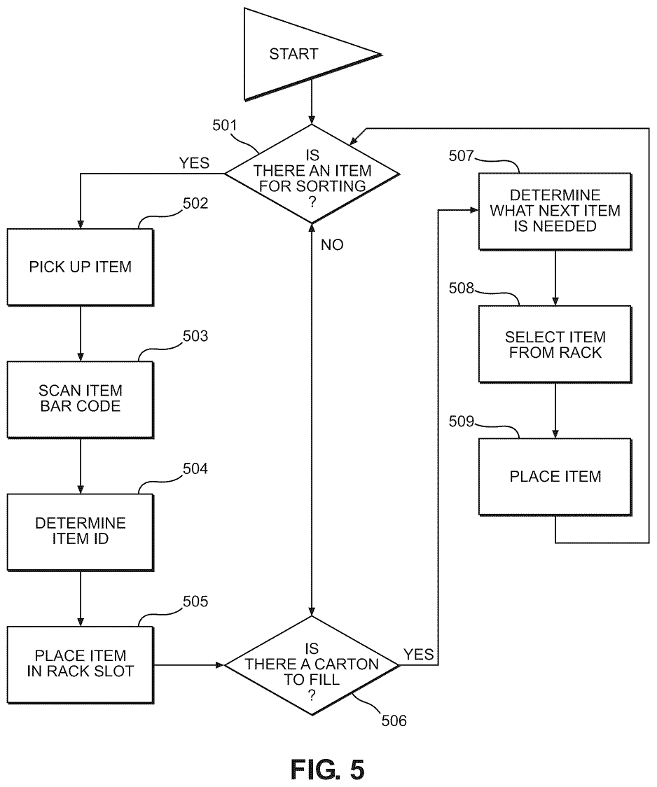

Referring now to FIG. 5, there is shown a flow chart of an embodiment of the method used by the apparatus to sort and store devices. The method of sorting and storing devices allows for both sorting of devices and storing of devices at the same time. Therefore, the method could start by either determining if there is an item which needs stored 501 or determining there is a device which is needed 506. For simplicity the remainder of this method will be described in a linear manner starting with determining an item which needs stored 501.

If it is determined that an item needs stored then the next step is to pick up the item 502. In one embodiment multiple items may come into the apparatus via a carton, in this embodiment a device is picked up out of the carton. Once an item is picked up by the robot it is identified. In one embodiment this identification is completed by using the scanner to scan a code on the item 503. Once scanned the device ID is determined 504. The device ID can include various identifying information, for example, for a mobile device the device ID may include the phones make, model, and color.

The system will then determine where the device should be placed in the at least one rack. In one embodiment a warehouse execution system (WES) is used to make this determination. Each time a device is picked up the system will determine which rack and slot on the rack is the closest location for placing the device. In one embodiment The WES, which has a smart ‘look ahead’ functionality, will check where the next rack pick is located, and will try to place this current device in a rack location closest to that. Each time a device is picked from the carton, WES will try to place it to minimize the movement between placement of that unit in the rack, and next pick from the rack. The device is then placed in the rack 505. The system can store the location of that device after it is placed. In some embodiments another item can be picked up for storing.

In some embodiments the WES can have additional features put in place in order to improve speed or minimize dependency on a warehouse management system. In one embodiment WES is configured to purge devices that have remained inactive for a specified duration. Devices can be selected and removed based on a predetermined date and part number. Additionally, SKUs identified as running low in volume can be purged using an identifier established within the WES. In another embodiment WES further includes a functionality for purging rejected devices as part of an error recovery mechanism. Devices that are deemed ineligible for inclusion in the system can be purged from the system. The Warehouse Execution System (WES) is configured to synchronize with the Warehouse Management System (WMS) exclusively at the start and end of the process. This can significantly speed up the placing and picking process.

In the shown embodiment the next step is to first determine if there is a item needed or a carton to be filled 506. In this embodiment if there are no needed items then the method can move to determining if an item needs to be stored. This loop ensures that the apparatus does not either sit idle unnecessarily or only performs the one method, i.e. storing method or the removal/fulfillment method.

If it is determined that a device is needed then the system will determined which type of device or item is needed 507. In this method the specific location of the desired device is also determined at this step. In one embodiment using the same warehouse execution system from above, the system can determine which device type is needed. The system can then determine in which rack and slot the closest device of that type is located. Once determined, the robot picks the item 508. In some embodiments the needed item is placed directly on a conveyor to exit the apparatus. In another embodiment the item is placed in a carton.

After the item is placed 509 the system moves back into the loop of determining if an item needs stored 501. If no item needs stored then the system will ask if an item is needed to exit the apparatus. In different embodiments a user could desire to stop the cyclic method. In this embodiment the easiest stopping points would be after an item is placed for storage 505 or after an item is placed to leave the apparatus 509.

It is therefore submitted that the methods, systems, and devices have been shown and described in what is considered the most practical and preferred embodiments along with specific examples. It is recognized, however, that departures may be made within the scope and these present examples are not intended to be limiting. One of ordinary skill the art will be able to discern that obvious modifications can be made without departing from the scope or spirit.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Similarly, it is to be realized that, it is not intended for any method set forth herein to be construed as requiring that its steps be performed in a specific order, unless otherwise set forth in the claims.

Therefore, the foregoing is considered as illustrative only of the principles of the disclosure. Further, since numerous modifications and changes will readily occur to those skilled in the art, it is not desired to limit the invention to the exact construction and operation shown and described, and accordingly, all suitable modifications and equivalents may be resorted to, are deemed to fall within.

1) An apparatus for sorting and storing devices, the apparatus comprising:
a frame configured to support a robot arm;
wherein the robot arm has a grabber secured to one end;
at least one rack positioned within reach of the robot arm;
a computer operably coupled with the robot arm.

2) The apparatus for sorting and storing devices of claim 1 further comprising a scanner secured to the frame wherein the scanner is operably coupled to the computer.

3) The apparatus for sorting and storing devices of claim 1 wherein a plurality of racks are arranged in a circular structure around the robot arm.

4) The apparatus for sorting and storing devices of claim 1, wherein each rack contains a predetermined number of slots.

5) The apparatus for sorting and storing devices of claim 1, further comprising a 3D camera system secured to the frame.

6) The apparatus for sorting and storing devices of claim 1, further comprising a first conveyor, wherein the first conveyor is configured to bring a device into range of the robot arm.

7) The apparatus for sorting and storing devices of claim 6, wherein the first conveyor is further configured to removed devices from the range of the robot arm.

8) The apparatus for sorting and storing devices of claim 6, further comprising a second conveyor.

9) The apparatus for sorting and storing devices of claim 8 wherein the second conveyor is configured to remove devices from the range of the robot arm.

10) The apparatus for sorting and storing devices of claim 6, further comprising a first carton placed on the first conveyor, wherein the first carton is configured to hold devices.

11) The apparatus for sorting and storing devices of claim 8 comprising a second carton placed on the second conveyor, wherein the second carton is configured to hold devices.

12) The apparatus for sorting and storing devices of claim 1 wherein the computer hosts a programmable logic controller.

13) The apparatus for sorting and storing devices of claim 12, wherein the programmable logic controller is configured to operate the robot arm in order to place devices in the at least one rack and remove devices from the at least one rack.

14) The apparatus for sorting and storing devices of claim 13, wherein the logic locates the first and closest available rack and slot on that rack where a device can be placed.

15) The apparatus for sorting and storing devices of claim 13, wherein the logic locates the first and closest available device which is needed and removes that device from the location.

16) The apparatus for sorting and storing devices of claim 12 wherein the programmable logic controller is configured to run a warehouse execution system (WES).

17) The apparatus for sorting and storing devices of claim 16 wherein the WES will determine exact placement of the devices on the at least one rack of the sorting apparatus.
